(19) United States
(12) Patent Application Publication
(10) Pub. No.: US 2015/0095014 A1
(43) Pub. Date: Apr. 2, 2015

(54) METHOD AND APPARATUS FOR PROVIDING CONTENT SCREENING AND RATING

(71) Applicant: Cellco Partnership d/b/a Verizon Wireless, Basking Ridge, NJ (US)

(72) Inventor: Ramesh MARIMUTHU, Edison, NJ (US)

(73) Assignee: Cellco Partnership d/b/a Verizon Wireless, Basking Ridge, NJ (US)

(21) Appl. No.: 14/039,989

(22) Filed: Sep. 27, 2013

(51) Int. Cl. G06F 17/27; G06F 17/28

(52) U.S. Cl. CPC G06F 17/2705; G06F 17/2735; G06F 17/28
USPC 704/9

(57) ABSTRACT

An approach is provided for content screening and rating. A content rating platform processes content directed to or originating from a user to determine one or more elements in the content. The content rating platform calculates a content rating for the content by comparing the one or more elements against at least one user-configurable dictionary, and then selects an operation for processing the content based on the content rating.

### BACKGROUND INFORMATION

Modern communications devices (e.g., smartphones, tablets, personal computers, etc.) enable users to receive and access a wealth of content and information from a variety sources (e.g., other users, content providers, etc.). However, the content that is directed to or originating from a user or user device can sometimes be inappropriate (e.g., profane content) or otherwise unsuitable. Accordingly, service providers face significant technical challenges to enabling users to be informed of the nature or characteristics of various content items (e.g., voice calls, text messages, social networking feeds, etc.) that may be received or sent by a user or group of users, and to be provided with options for handling the content. Therefore, there is a need for providing content screening and rating for both incoming and outgoing content items.

### BRIEF DESCRIPTION OF THE DRAWINGS

Various exemplary embodiments are illustrated by way of example, and not by way of limitation, in the figures of the accompanying drawings in which like reference numerals refer to similar elements and in which:

FIG. 1 is a diagram of a system capable of providing content screening and rating, according to one embodiment;

FIG. 2 is a diagram of components of a content rating platform, according to one embodiment;

FIG. 3 is a diagram of a cloud-based architecture for a content rating platform, according to one embodiment;

FIG. 4 is a flowchart of a process for providing content rating, according to one embodiment;

FIG. 5 is a flowchart of a process for screening content based on content rating, according to one embodiment;

FIG. 6 is a flowchart of a process for presenting a content rating information, according to one embodiment;

FIGS. 7A-7F are diagrams of user interfaces for presenting content ratings for different content types, according to various embodiments;

FIG. 8 is a diagram of representations of content ratings, according to one embodiment;

FIGS. 9A and 9B are diagrams of user interfaces for presenting rating information for content originators, according to various embodiments;

FIG. 10 is a diagram of a computer system that can be used to implement various exemplary embodiments; and

FIG. 11 is a diagram of a chip set that can be used to implement various exemplary embodiments.

### DESCRIPTION OF EXAMPLE EMBODIMENTS

An apparatus, method, and system for providing content screening and filtering, is described. In the following description, for the purposes of explanation, numerous specific details are set forth in order to provide a thorough understanding of the present invention. It is apparent, however, to one skilled in the art that the present invention may be practiced without these specific details or with an equivalent arrangement. In other instances, well-known structures and devices are shown in block diagram form in order to avoid unnecessarily obscuring the preferred embodiments of the invention.

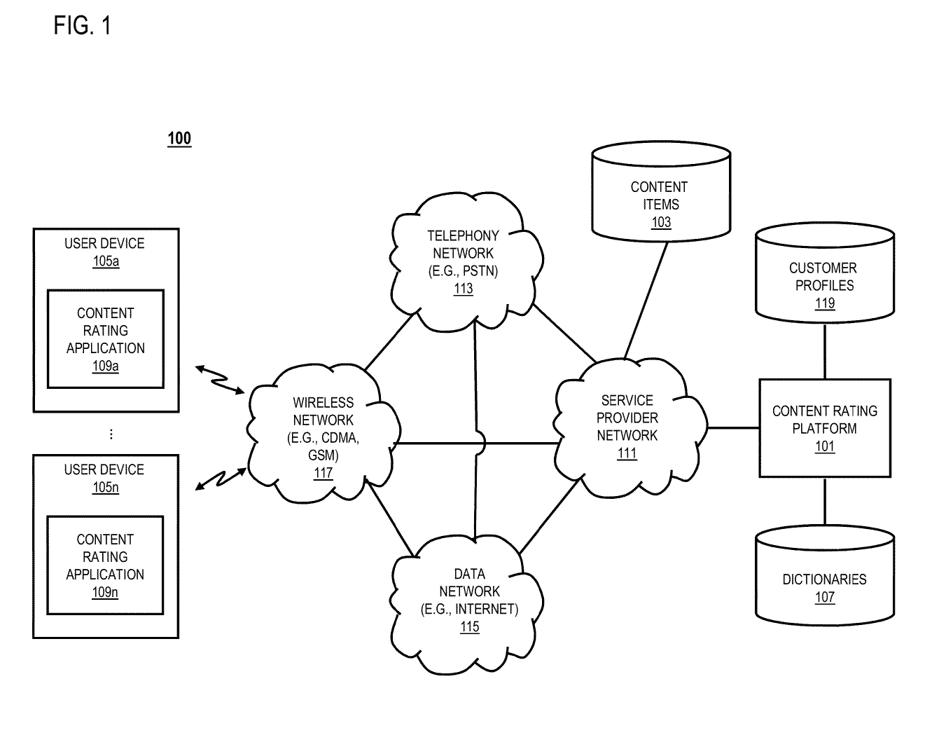

FIG. 1 is a diagram of a system capable of providing content screening and rating, according to one embodiment. As noted above, with greater accessibility to content and information over modern communications networks, users often need and/or want tools to help manage the content that is directed to or sent by them and/or their devices. For example, users may want to block profanity from reaching their devices or originating from their devices, particularly if the devices are used by children. As another example, employers may want to limit abusive communications directed to or originating from their employees. Traditionally, content providers have been responsible for rating content for screening by user devices. For example, content such as movies, music, television programs, and games are rated by their respective ratings boards and associations (e.g., the Motion Picture Association of America (MPAA) for movies). However, other types of content that are directed to or sent by users such as voice mail, E-mail, text messages, social networking feeds, etc. often remain unrated and unscreened, thereby subjecting users to potentially inappropriate and/or unwanted content. Even in the case of rated content (e.g., movies, music, etc.), the ratings provided by their respective associations and boards are targeted to a general audience, and do not provide opportunity for personalization of the ratings, which again may lead to users receiving or sending inappropriate and/or unwanted content.

To address this problem, as shown in FIG. 1, a system 100 introduces a capability for a content rating platform 101 to process content items 103 (e.g., communications content, media content, application content, gaming content, etc.) that are directed to or sent by users or user devices 105a-105b (also collectively referred to as user devices 105) to determine elements (e.g., words, images, sounds, etc.) that are present in the content. In one embodiment, the user devices include mobile phones and/or another other computing device capable of receiving content items 103 (e.g., including machine to machine (M2M) and other non-traditional devices). In one embodiment, the content rating platform 101 then calculates a content rating for the particular content items 103 by comparing the elements determined to be in the content items 103 against one or more dictionaries 107. By way of example and not limitation, elements include words, images, sounds, videos, or other components of the content items 103 that can be parsed or otherwise recognized from the content items 103. In one embodiment, the dictionaries 107 are user-configurable and may be related to specific themes. For example, if the content rating platform 101 is rating content items 103 based on profanities contained therein, the content rating platform 101 may use a dictionary 107 that is themed for profanities (e.g., contain words that are profanities or indicative of profanities). Based on the rating, the content rating platform 101 can then select or recommend an operation for handling or processing the rated content items 103. Example of possible operations include, but are not limited to, screening the rated content items 103 (e.g., including blocking, masking, substituting, etc.), reporting rated content items 103, alerting users about the rated content items 103, etc.

Although various embodiments are described primarily with respect to a screening and rating against a profanity themed dictionary, it is contemplated that the dictionaries 107 can be based on any theme (e.g., themes based user moods, topics, interests, associated with specific contacts/senders/originators, context, etc.). Accordingly, the ratings resulting from using a particular themed dictionary 107 will be based on the corresponding theme of the applied dictionary 107. For example, instead of a profanity theme, a dictionary may contain words or other elements (e.g., images, sounds, etc.) that are related to a feeling of happiness. In this case, the content rating platform 101 can use the happiness dictionary 107 for rating content items 103 to represent the likelihood that the content items 103 will invoke a feeling of happiness (e.g., based how many times the word “smile” or other similar word appears in a content item 103).

In one embodiment, the content rating platform 101 employs a default dictionaries 107 (e.g., a default profanity dictionary) that is user configurable. In other words, a user has the ability to create the user's own dictionary 107. In the case of a profanity dictionary, the user selects the profanities that are to be used for rating and screening by (1) inputting the elements (e.g., words, images, etc.) that the user personally considers profane, or (2) supplements or modifies the default profanity dictionary to configure the dictionary according to the user's preferences. In this way, the ratings provided by the content rating platform 101 are personalized to a particular user as opposed to general ratings provided ratings bodies (e.g., the MPAA).

In one embodiment, once content items 103 are rated, the content rating platform 101 enables users to configure operations for handling the content items 103 based on those ratings. For example, in addition to the screening functions discussed above, the user can configure the platform 101 to provide: (1) reporting capabilities (e.g., ratings reports for content items 103; number of content items 103 in each rating category, etc.); (2) searching capabilities (e.g., search for content items 103 based on their ratings); (3) content organization capabilities (e.g., creating folders based on ratings categories and automatically storing content items 103 according to ratings); (3) alerting capabilities (e.g., presenting alerts when content items 103 of a certain rating is being accessed); and the like.

In one embodiment, the system 100 includes an application suite (e.g., content rating applications 109a-109n, also collectively referred to as content rating applications 109, that work in tandem with or independently from the content rating platform 101) to control or rate the appearance of specific elements (e.g., the use of abusive/bad/curse language) in various content types such as voice calls, text messages, multimedia messages, E-mail, voicemail, music, video, movies, games, social networking feeds, etc. In one embodiment, the application suite enables users to screen content items 103 (e.g., by blocking, masking, substituting, etc.) elements matching terms appearing in the dictionaries 107. For example, for profanity screening applications, the application suite enables users to block and/or mask all types of abusive words and/or content received at the user device 105.

In one embodiment, the application suite can be run by individual users, groups of users, and/or as a parental control application on minors' user devices 105 such as mobile phone, video game systems, computers, and other electronic devices. For example, when used for parental control, parents can configure a minor's device and content settings (e.g., voicemail settings) in a way that certain ratings cannot be played or accessed by the minors. For example, with respect to a voicemail use case, if the minor tried to play a voicemail rated has profane or higher, the minor may hear a message, “Your parents have blocked you from playing voicemails that are rated X or higher. Please contact your parents for changing the configuration.” In another embodiment, parents can also configure content settings so that content items 103 of a certain rating are deleted immediately. Parent may also, for instance, configure forwarding of the content items 103 (e.g., X-rated voicemails) to a destination device 105 (e.g., a parent's device 105).

In one embodiment, the application suite (e.g., content rating application 109) runs in the background of the user device 105 (e.g., a user's mobile phone or any other type of computer/device used by the user). The content rating application 109, for instance, functions as a “content screener” (e.g., a “profanity screener” when used with a profanity themed dictionary 103) during the processing of content directed to or otherwise used at the device 105.

In another embodiment, the content rating application 109 can also function as a “content reporter” (e.g., a “profanity reporter” when used with a profanity themed dictionary 103). By way of example, a “content reporter” or “profanity reporter” may assign a content rating (e.g., a profanity rating) for the content items 103 based on the number elements (e.g., profane words, profane images, profane sounds, etc.) present in the content items 103. As previously discussed, the content items 103 can be any content directed to or originating from the user or user device 105, and include, for instance, a voicemail, text message, E-mail, music, audio, video, games, movies, other content applications, etc.

As described above, the content rating platform 101 and/or content rating application 109 may be implemented of an individual user so that the application 109 is running as, for instance, a background process of the user device 105. In addition or alternatively, the content rating platform 101 and/or the content rating application 109 can be implemented at a service provider network 111 (e.g., a carrier network) via, for instance, a voicemail platform on the service provider network 111. In this way, the content rating platform 101 performs its content rating and screening functions on the network side. In one embodiment, implement the content rating platform 101 in the service provider network 111 enables servicing of potentially millions of subscribers of the service provider network 111. In yet another embodiment, the content rating platform 101 can be implemented as a cloud-based application to provide a carrier agnostic platform that can be used by multiple carriers, enterprises, and/or individual customers.

In one embodiment, the content rating platform 101 can operate in either an offline processing mode or an online processing mode. For example, in an offline processing mode, the content rating platform 101 performs its content rating and screening function on content items 103 that have been received and/or stored (e.g., by the user device 105 or other network content service such as a voicemail platform). The processing of the content items 103 to determine content ratings and screening can be performed in the background. In an online processing mode, the content rating platform 101, for instance, performs real-time screening and rating functions when a content item 103 is accessed or played back (e.g., when a voicemail is played back) rather than screening and rating content items 103 that have already been stored. In one embodiment, the offline processing mode differs from the online processing mode in that the offline mode stores altered or screened content items 103 for later access, whereas in the online mode makes alterations to the content items 103 on the fly during playback without affecting the original content file.

As noted previously, in one embodiment, to screen and rate content items, the content rating platform 101 relies on themed dictionaries 107 that contain reference words or elements that are to matched against incoming content items 103 to calculate content ratings. The dictionaries 107 are then, for instance, applied to the content items 103 that are directed to the user device 105 to determine content ratings based on the theme of the dictionary 107 (e.g., profanity ratings if the dictionary 107 contain elements or words associated with a profane theme). Although various embodiments discuss communications content (e.g., voicemails, text messages, instant messages, E-mails, news feeds, etc.) as example of the content items 103 to be screened and rated, it is contemplated that the various embodiments described herein apply to any type of content item 103 that is directed to or presented to the user at the user device 105.

In one embodiment, service providers may apply various embodiments of the content screening and rating mechanism described herein to all content items 103 or to a subset of the content items 103. For example, service providers may tag content items 103 for screening and rating by applying a flag or other designation to mark the content items 103. In this way, when a user selects one of the flagged content items 103 for access, the system 100 will apply the content screening and rating mechanism. By way of example, in cases where a subset of content items 103 is selected for screening and rating, service providers may tag content items 103 with high likelihood of being responsive to particular rating themes (e.g., likely to contain profanities based on historical and/or contextual information).

In one embodiment, the system 100 applies content screening and rating by installing content rating applications 109 at respective user devices 105 to perform all of a portion of the content filtering functions of the various embodiments described herein. In addition or alternatively, the content rating platform 101 may perform all or a portion of the content screening and rating functions. It is also contemplated that any other component (e.g., service provider voicemail platform) of the system 100 may perform all or a portion content screening and rating functions in addition to or in place of the content rating applications 109 and the content rating platform 101. By way of the example, the screening and rating functions include, but are not limited to, screening incoming content items 103 to prevent the user from seeing data or messages that are rated at a threshold value.

In one embodiment, the dictionaries 107 may be configurable and/or set manually by the user. More specifically, the user can set or modify default parameters based on the specific content type in question (e.g., voicemails versus images, video, etc.). By way of example, the user may manually configure or set the dictionaries on an ongoing basis for each type of content item 103. In other embodiments, the user may configure or set the dictionaries 107 on a one time or periodic basis; and then, the system 100 can derive or otherwise determine dictionaries 107 for other content items 103 based on the initial configuration data. It is contemplated that dictionaries 107 can be specific to individual users, groups of users, enterprises, etc.

In one embodiment, the content rating platform 101 uses a natural language interface to screen and rate content items 103. For example, the content rating platform 101 can recognize (e.g., via natural language processing) topics in the data that can potentially match user-configured dictionaries 107 for calculating content ratings. In one embodiment, the content rating platform 101 is capable of recognizing abbreviations, nicknames, and other shorthand typically used in messaging or other communications that may also match elements in the dictionaries 107.

In one embodiment, when the content rating platform 101 detects incoming content items 103 that achieve a certain rating, the content rating platform 101 can notify the originator of the content item 103 (e.g., a sender of a voicemail message), the recipient of the content item 103 (e.g., the user), and/or other designated parties (e.g. parents, managers, reporting authorities, law enforcement, etc.). For example, when notifying the recipient, the content rating platform 101 can specify who the sender is and what ratings were triggered. When notifying the originator of the data (e.g., the sender), the content rating platform 101 can indicate to the sender that the intended recipient has decided to screen incoming content item 103 because of the content rating. When notifying other designated parties, the content rating platform 101 can select which parties to notify based on contextual information. For example, if contextual information (e.g., location, time of day, etc.) indicates that a user is at work, the content rating platform 101 can notify the user's manager of content items 103 that are of a certain rating. In one embodiment, such alerts or notifications can be logged and a historical report can be generated to determine the pattern of how someone has communicated over a period of time (e.g., months, years, etc.). For example, such patterns can be used to facilitate delivery of behavioral therapy or for law enforcement purposes.

In one embodiment, the content rating platform 101 interacts with the content items 103, the user devices 105, and other components of the system 100 through the service provider network 111. The service provider network 111, in turn, can interact with one or more other networks, such as a telephony network 113, a data network 115, and/or a wireless network 117. Although depicted as separate entities, networks 111-117 may be completely or partially contained within one another, or may embody one or more of the aforementioned infrastructures. For instance, the service provider network 111 may embody circuit-switched and/or packet-switched networks that include facilities to provide for transport of circuit-switched and/or packet-based communications. It is further contemplated that networks 111-117 may include components and facilities to provide for signaling and/or bearer communications between the various components or facilities of system 100. In this manner, networks 111-117 may embody or include portions of a signaling system 7 (SS7) network, or other suitable infrastructure to support control and signaling functions.

In exemplary embodiments, any number of customers may access the content rating platform 101 through any mixture of tiered public and/or private communication networks. According to certain embodiments, these public and/or private communication networks can include a data network, a telephony network, and/or wireless network. For example, the telephony network may include a circuit-switched network, such as the public switched telephone network (PSTN), an integrated services digital network (ISDN), a private branch exchange (PBX), or other like network. The wireless network may employ various technologies including, for example, code division multiple access (CDMA), enhanced data rates for global evolution (EDGE), general packet radio service (GPRS), mobile ad hoc network (MANET), global system for mobile communications (GSM), Internet protocol multimedia subsystem (IMS), universal mobile telecommunications system (UMTS), etc., as well as any other suitable wireless medium, e.g., microwave access (WiMAX), wireless fidelity (WiFi), satellite, and the like. Additionally, the data network may be any local area network (LAN), metropolitan area network (MAN), wide area network (WAN), the Internet, or any other suitable packet-switched network, such as a commercially owned, proprietary packet-switched network, such as a proprietary cable or fiber-optic network.

In one embodiment, a content rating platform 101 may perform screening and rating functions based on user requests. In one embodiment, the content rating platform 101 may match the user against customer profiles 119 in order to validate the user request. In one embodiment, validating a request may be further based on matching one or more parameters in the request against the context of a user, user device 105, or combination thereof associated with the user's account as specified in, for instance, the customer profiles 119. In one embodiment, the request to initiate screening and rating of incoming content items 103 may be based on a request to playback or otherwise access the content items 103.

In one embodiment, the content rating platform 101 may create user configurable dictionaries 107 that are applied to incoming content items 103. As described above, the data or content items 103 that may be screened and rated include one or more communication messages (e.g. voicemails, text, SMS, email, voice-to-text, or other real-time messages in text format), one or more information feeds (e.g. news feeds, ticker blocks, blog feeds, forum feeds), Internet content or a combination thereof. In one embodiment, separate dictionaries 107 can be maintained for incoming and outgoing content items 103 (e.g., incoming and outgoing communication messages). In another embodiment, the content rating platform 103 can maintain individual dictionaries for different originators (e.g., senders) of the content items 103. For example, when a user sends or receives a message to Contact A, one or more dictionaries 107 specific to Contact A can be used to assess the content items 103. It is contemplated that content rating platform 103 can create any number of dictionaries 107 for a given context and/or originator (e.g., contact).

In one embodiment, the form of screening and rating is dependent on the type of content item 103 that is to be filtered. For example, Internet content, video, images, etc. that are to be filtered may be blacked out or blurred so that the user cannot read the relevant information, while messages may be filtered by redacting content or by preventing the message from being played back or displayed to the user. It is contemplated that the system 100 may use any form of screening applicable to a given data type.

In one embodiment, the content rating platform 101 may also calculate a rating for an originator of rated content items 103 (e.g., a sender or contact associated with a voicemail message). For example, the content ratings generated for one or more content items 103 may be used to calculate an originator rating for the originator of the content. For example, if the voicemail messages are typically rated as highly profane, the same rating can be applied to a sender or originator of the messages. In one embodiment, the originator ratings can be updated dynamically as new items are received. In other embodiments, the content ratings for older items can decay so that originator ratings can be more reflective of the current rating of associated content items 103. In one embodiment, the content rating platform 103 enables users to block content items 103 (e.g., messages) from contacts who are of a certain rating. Accordingly, such blocked contacts will not be able to send messages to the user.

In one embodiment, the content rating platform 101 may present a user interface displaying a listing of the content items 103 and/or originator of the content items 103 along with associated content ratings and/or originator ratings. The user interface may use any ratings scales or representations (e.g., color, icons, symbols, text, haptics, etc.) to convey ratings information. In one embodiment, the user interface may be presented at the user device 105 and/or any other component of the system 100 capable of presenting the user interface.

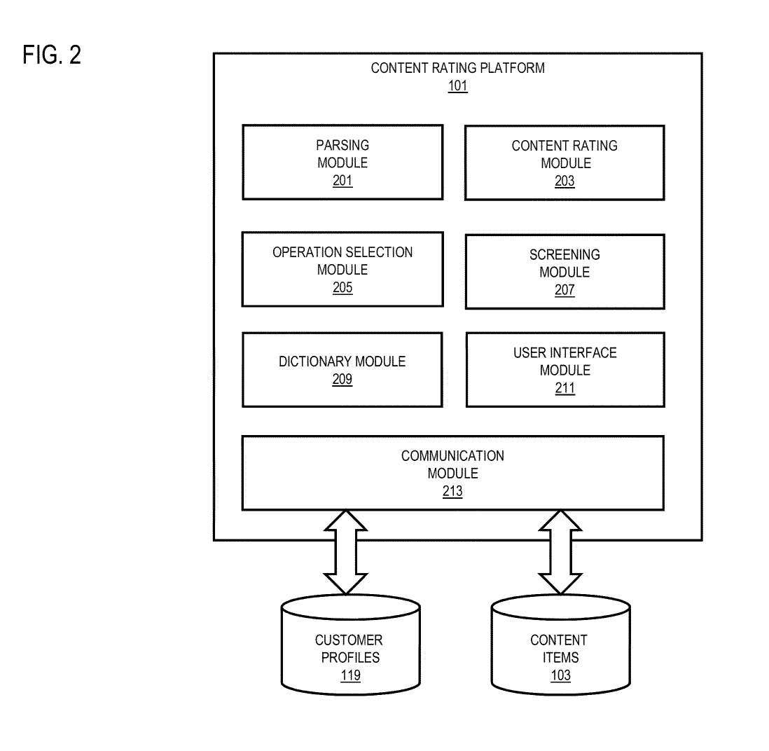

FIG. 2 is a diagram depicting the components of the content rating platform 101, according to one embodiment. The content rating platform 101 includes various executable modules for performing one or more computing, data processing and network based instructions that in combination provide a means for screening and rating incoming and outgoing content items 103. Such modules can be implemented in hardware, firmware, software or a combination thereof. Although the content rating platform 101 is depicted as a standalone component, it is contemplated that the content rating platform 101 and/or its functions may be implemented in other components of the system 100 including the user devices 105 and the service provider network 111.

By way of example, the content rating platform 101 may include a content parsing module 201, a content rating module 203, operation selection module 205, screening module 207, a dictionary module 209, a user interface module 211, and a communication module 213. These modules 201-213 can interact with customer profiles 119 and content items 103 in support of their functions. According to some embodiments, the customer profiles 119 and content items 103 are maintained and updated based, at least in part, on one or more operations (e.g., communications operations) or transactions conducted on user devices 105.

In one embodiment, the content parsing module 201 processes content items 103 that are directed to or originating from a user of user device 105 to recognize elements that are present in the content items 103. In one embodiment, the elements and the means for recognizing those elements can be dependent on the type of content items 103. For example, for voicemail content items 103, the content parsing module 201 can use a voice recognition engine to convert speech to identify words as elements that are contained in the voicemail. For image content, the content parsing module 201 can use image or object recognition to identify visual objects as elements in the image content item 103. It is contemplated that the content parsing module 201 can support any mechanism for parsing or recognizing individual elements within the range of available types of content items.

After identifying elements that are present in specific content items 103, the content parsing module 201 interacts with the content rating module 203 to calculate ratings. In one embodiment, the content rating module 203 compares or matches the identified elements against one or more dictionaries 107 specified by a user. In one embodiment, the comparison or matching results in a count or histogram that specifies, for instance, the number of times each elements present in the dictionary appears in the content item 103. In the case of profanity screening, for instance, the content rating module 203 can determine how many times a particular profanity contained in a profanity dictionary 107 is present in a parsed content item 103. The ratings are then, for instance, based on the count information. It is also contemplated that the content rating module 203 can use any algorithm or method for rating content items 103 in addition to or in place of the element or word counting mechanism described above. For example, weighting can be applied to certain terms or words or mere presence of a word or element can trigger a certain rating (e.g., one instance of nudity can trigger an X rating for a content item 103).

In one embodiment, the content rating module 203 can also calculate originator ratings for originators (e.g., senders or other contacts) associated with a rated content item 103. In this case, the content rating module 203 can determine the ratings for content items 103 typically sent by a particular originator or sender. These content ratings can then become a basis for calculating an originator rating for the sender. For example, a contact who always send messages that are rated as very happy will also be rated as very happy. In one embodiment, the originator ratings can be updated as new content items 103 (e.g., new messages, voicemails, etc.) are received from the same originator.

After preforming the rating function, the content rating module 203 interacts with the operation selection module 205 determine what operations are to be performed on the rated content items 103 based on the calculated content and/or originator ratings. In one embodiment, the content selection module 205 can determine user or default preferences to select the appropriate operation for a rated content item 103. In one embodiment, the preferences can be retrieved from the customer profiles 119. In some embodiments, the operation selection module 205 may use contextual information (e.g., date, time, location, history, etc.) to determine the operations to performed. For example, content items 103 with a high profanity rating may be blocked or screened during a user's work hours but only flagged during non-work hours. In another example, contextual information regarding the presence of other users (e.g., presence of children) can be used as at least one factor for determining an appropriate operation for rated content items 103.

In one embodiment, if the operation selected for processing the rated content items is a screening operation. The operation selection module 205 can interact with the screening module 207 to initiate screening of the rated content items 103. In one embodiment, screening may include blocking, masking, substituting, etc. elements that are identified within rated content items 103. For example, with respect to a use case where content items 103 are voicemails being screened for profanity, when a voicemail is directed to or originating from a user device 105 (e.g., a mobile phone or any other electronic device), the voicemail is screened in the background (e.g., via offline processing) or in real-time (e.g., via online processing) for profanity. In this example, the user has the ability to configure what operations to perform on the profanity found in the voicemail. The user, for instance, can configure the following: (1) delete the profane portion of the content and leave a blank space; (2) delete and replace the profane portion with a long beep; and/or (3) delete and replace (e.g., substitute) the profane portion with a word/phrase or other element of the user's choosing with or without a beep. In one embodiment, the user also has the ability to configure the replacement words/phrases unique to the profanity found in the voicemail. As an example, if the abusive word “fu**” is found, then the screening module 207 can replace the profanity with “fun”. If the profanity “stu***” is found, then the screening module 207 can replace the profanity with “great”. In other words, in one embodiment, the user has the ability to replace any word or element in the content item 103 whether the word or element is abusive or not with any other word or element of the user's choosing.

In one embodiment, the content rating platform 101 also includes a dictionary module 209 for enabling user configuration of the dictionaries 107. For example, the dictionary module 209 enables to personalize or create dictionaries 107 according to any user specified themes. To customize a profanity dictionary 107, for instance, the dictionary module 209 may enable user input of elements or words that the user considers to be profane and the removal of terms that the user considers to not be profane. In one embodiment, the dictionary module 209 can create new dictionaries based on themes (e.g., moods, interests, etc.) specified by a user. For example, to specify a happy theme, the user may include words such as “happy”, “smile”, “beautiful”, “fun”, etc. in the happy dictionary 107. In this way, the content rating module 203 can compare elements identified in content items 103 to determine whether any of the elements in the content items 103 match the words in the dictionary 107. If there are many matches or counts matching the dictionary term, the content rating module 203 will rate content items 103 highly with respect to happiness.

As shown, the content rating platform 101 also includes a user interface module 211 that enables user interaction with the content rating platform 101. In one embodiment, the user interface module 211 facilitates generation of various interfaces for enabling users to interact with the content rating platform 101. This includes, for example, generation of a login interface for enabling user registration and/or access to the content screening and rating services. More specifically, the user interface module 211 can present content ratings information to users via graphical representations. In another embodiment, the user interface module 211 supports reporting functions (e.g., by presenting content rating reports that, for instance, list content items 103 along with their respective content or originator ratings) as well as searching functions (e.g., by enabling searching for content items 103 that meet certain rating criteria).

In one embodiment, the user interface module 211 supports a website portal which provides an alternative method to use various features and functions of the content rating platform 101. For example, the web portal can be used to during configuration of the individual features (e.g., customizing dictionaries 107, specifying rating levels and criteria, etc.).

In one embodiment, the communication module 213 executes various protocols and data sharing techniques for enabling collaborative execution between the content rating platform 101, the user devices 105, the content rating application 109, the networks 111-117, and other components of the system 100. In addition, the communication module 213 enables generation of signals for communicating with various elements of the service provider network 111, including various gateways, policy configuration functions and the like.

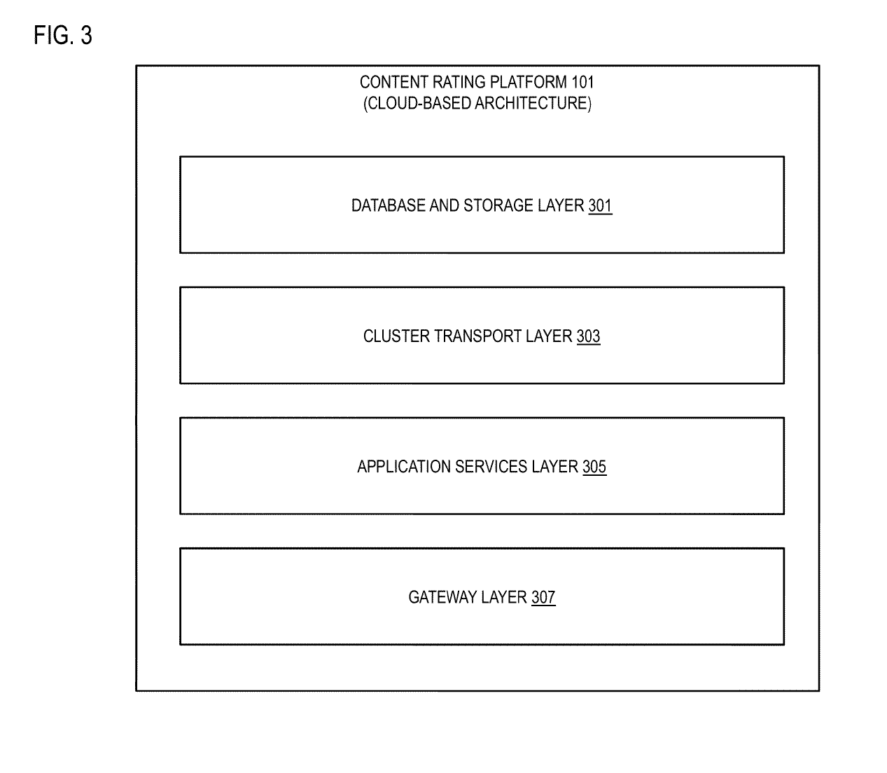

FIG. 3 is a diagram of a cloud-based architecture for a content rating platform, according to one embodiment. By way of example not limitation, the content rating platform 101 can be implemented as: (1) an individual user-based implementation, (2) a carrier-based implementation, and/or (3) a cloud-based implementation. As previously noted, an individual-based implementation can be based on the content rating applications 109 executing on user devices 105. The application 109, for instance, will run in the background of a user's mobile phone or other type of computer/device and provide content screening and rating for that particular device. Content items 103 would also be stored or otherwise processed at the device 105.

In a carrier-based implementation, the content rating platform 101 will be run on the carrier's network 111 (e.g., the carrier's voicemail platform in the case of screening and rating content items 103 that are voicemails). In this carrier-based approach, the content rating platform 101 can serve all of the subscribers of the implementing carrier. In a use case where the content items 103 to be screened and rated are voicemail, the user's voicemails will be stored at the server level. Also, the processing (e.g., rating and screening) will be performed at the server level. The voicemail will be played back at the user device 105 by using audio streaming or by downloading the audio file and playing back the file locally.

In a cloud-based approach, the content rating platform 101 can run in a cloud network, thereby making the platform 101a carrier agnostic platform that can be used by multiple carriers, enterprises, and/or individual customers. In a use case where the content items 103 to be screened and rated are voicemail, the user's voicemails will be stored at the cloud server level. Similar to the carrier-based implementation, a voicemail will be played back at the user device 105 by using audio streaming or by downloading the audio file and playing back the file locally.

FIG. 3 illustrates an example architecture for a cloud-based implementation of content rating platform 101. The example architecture of FIG. 3 is provided as an example and is not intended as a limitation. It is contemplated that the various embodiments of the system 100 described herein can be applied on any equivalent architecture. As shown in FIG. 3, in one embodiment, a cloud-based content rating platform 101 includes, for instance, a database and storage layer 301, a cluster transport layer 303, an application services layer 305, and a gateway layer 307. In this example, cloud-based content items 103 are stored in the database and storage layer 301. The database and storage layer 301 includes, for instance, multiple storage area networks (SANs), databases, and/or other storage nodes for storing high volumes of content items 103 (e.g., voicemail audio files).

The cluster transport layer 303 communication services to link the application services layer 305 to the database and storage layer 301. The application services layer 305 contain modules and engines for applications and services that support the content screening and rating functions of the content rating platform 101. These modules and engines include the modules described with respect to FIG. 2 as well as other engines such as: enterprise rules engine, subscriber rules engine, carrier rules engine, voicemail content rating engine, E-mail content rating engine, text content rating engine, speech content rating engine, social media posts content rating engine, movie content rating engine, web portal services, master content rating engine, law enforcement services, search and reporting services, billing provisioning and account services, data encryption services, and/or the like.

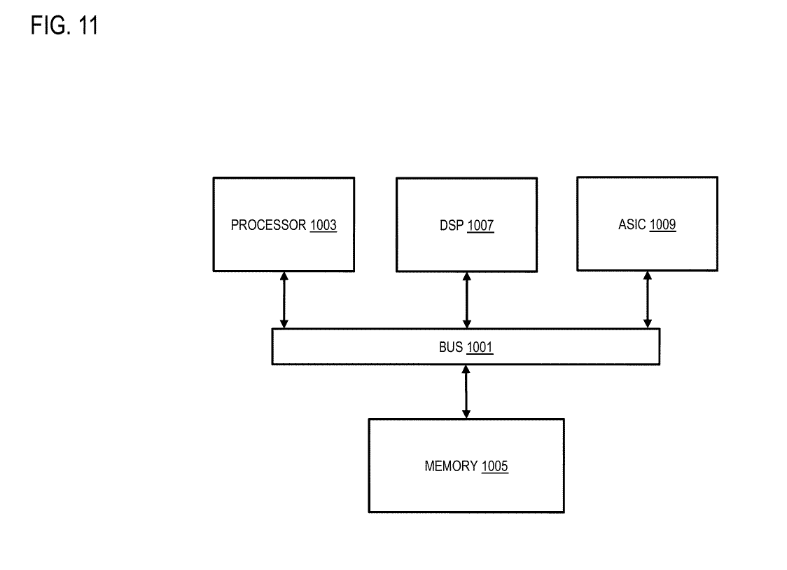

In one embodiment, the application services layer 305 is accessed by subscribing carriers, enterprises, individuals, and/or other subscribers through the gateway layer 307. The gateway layer 307 enables, for instance, implementation of a multi-tenant enterprise content rating platform 101. More specifically, the cloud-based content rating platform 101 of FIG. 11 is designed so that the platform 101 can be used to service multiple wireless carriers or Mobile Virtual Network Operators (MVNOs), enterprises, and other subscribers.

In one embodiment, carriers, enterprises, etc. can customize the content rating platform 101 to provide unique features and a customized look and feel. For example, the cloud-based content rating platform 101 is a multi-tenanted platform that can be sliced any number of times based on demand. To serve multiple tenants and allow for customization, the content rating platform 101, for instance, can dedicate a percentage of its architecture (e.g., 80%) as standard among the tenants and a remaining percentage (e.g., 20%) is available for customization by carriers and enterprises. In one embodiment, subscribers can be differentiated by mobile number or other unique identifier so that the subscribers will receive the features that are assigned to them.

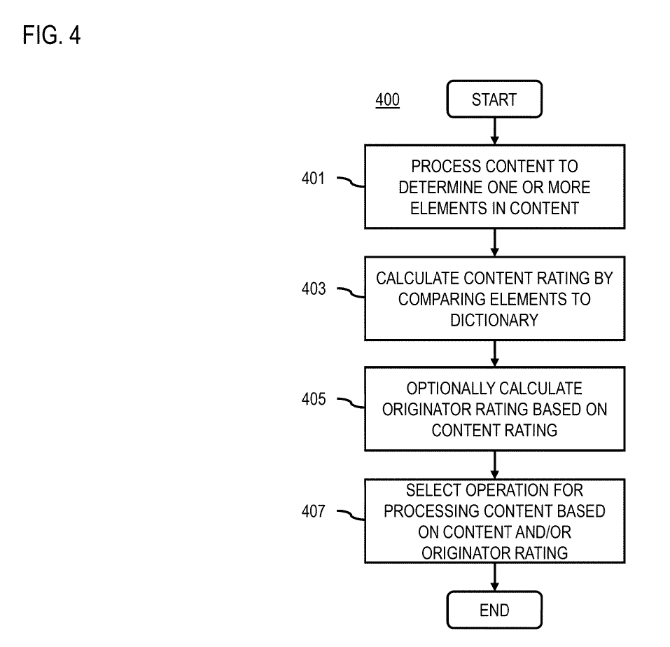

FIG. 4 is a flowchart of a process for providing content rating, according to one embodiment. In one embodiment, the content rating platform 101 performs the process 400 and is implemented in, for instance, a chip set including a processor and a memory as shown in FIG. 11. In addition or alternatively, the content rating application 109 may perform all or a portion of the process 400.

In step 401, the content rating platform 101 processes content (e.g., content items 103) directed to or originating from a user to determine one or more elements in the content. In one embodiment, the content includes communications content, media content, gaming content, application content, or a combination thereof. In one embodiment, the content rating platform 101 can monitor (e.g., at the device 105 or a content server such as a voicemail server) for content items 103 are sent to or from a user device 105 or a set of user devices 105 associated with a user. For example, the content rating platform 101 can perform content screening and rating functions for an individual device 105, a set of devices 105 associated with a single user, a set of devices 105 associated with a group of users 105, or a combination thereof. As discussed previously, the type of processing to determine elements in the content can be dependent on the type of content. Accordingly, the content rating platform 101 can employ speech recognition engines, image or object recognition engines, sound recognition engines, and the like to identify individual elements that are present in content items. For example, when processing a voicemail message, the content rating platform 101 applies a speech recognition engine to parse individual words as elements of the content.

In one embodiment, the screening and rating feature may be turned on or off by a user as long as that user does not come under the control of another user (e.g., a parental control function).

In step 403, the content rating platform 101 calculates a content rating for the content by comparing the one or more elements against at least one user-configurable dictionary 107. In one embodiment, the at least one user-configurable dictionary 107 is based on one or more themes (e.g., a profanity theme). In one embodiment, the users can modify or create dictionaries 107 directed to any theme (e.g., mood, interest, etc.) specified by the user. For example, in a profanity screening use case, the content rating platform 101 can be configured with a default profanity word/image/sound dictionary 107 that is modifiable by the user. In one embodiment, the dictionary 107 can be created at the account level (e.g., based on account information specified in user profiles 119). In this way, all devices 105 listed under an account will have the same dictionaries 107. This can be useful, for instance, for parents or employers to apply profanity controls to all members of the family or company equally. In some embodiments, the content rating platform 101 allows more than one dictionary 107 per account. As an example, adults listed in the account could use one dictionary 107 (e.g., a smaller dictionary with less restrictions), whereas minors listed in the account could use another dictionary 107 (e.g., a larger dictionary with more restrictions).

In one embodiment, the user can either specify or use default parameters for specifying the ratings categories as well as the criteria for applying the rating to a given content item 103. For example, when screening for profanities, the content rating platform 101 may have the following: (1) Not Rated=NR rating; (2) No abusive/curse words=G rating; (3) 1-3 abusive/curse words=X rating; (4) 4-6 abusive/curse words=XX rating; and (5) 6 and above abusive/curse words=XXX rating. In one embodiment, the user can override or manually set ratings determined by the content rating platform 101.

In step 405, the content rating platform 101 optionally calculates an originator rating for an originator of the content based on the content rating. In one embodiment, the content rating platform 101 updates the originator rating based on one or more other content ratings associated with other content directed to the user by the originator. In one embodiment, the originators may correspond to contacts in the user's contact list. In this embodiment, the content rating platform 101 can indicate the originator rating (e.g., a profanity rating) of the individual contacts. By way of example, the content rating platform 101 will calculate the originator or contact ratings automatically based on the historical ratings for content items 103 associated with the contact. For example, in a voicemail use case, the originator rating can be based on the abusive/curse language historically detected in the voicemail received from the contacts.

In one embodiment, the originator ratings are calculated and displayed on a real time basis. As an example, if the user with a no profanity rating leaves a voicemail with a few curse words, as soon as the content rating platform 101 completes its screening and rating, the content rating platform 101 can modify the contact list with a new originator rating for the given contact. In one embodiment, the originator rating can be associated with an expiration period (e.g., a week, month, or other number of days). In one embodiment, the user can configure this period. At the end of the expiration period, the originator rating of the contact can go down by a predetermined number of levels (e.g., one level, two level, back to the lowest level, etc.). In one embodiment, the user may also override originator ratings set by the content rating platform 101.

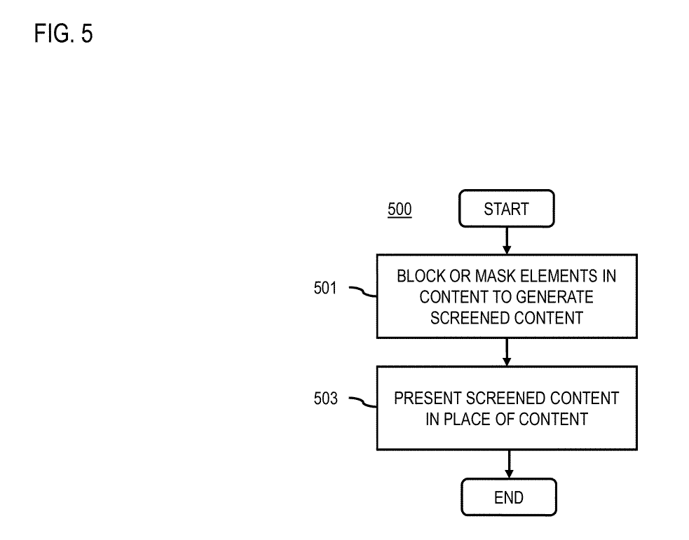

In step 407, the content rating platform 101 selects an operation for processing the content based on the content rating. For example, the content rating platform 101 has the ability to treat content items 103 (e.g., voicemails) based on their content ratings. In one embodiment, the user may define what operation to perform on a content item 103 that has a certain content rating. For example, in a voicemail use case, the content rating platform 101 can perform the screening operations described with respect to FIG. 5 below.

In one embodiment, one possible operation is to organize and file content items 103 according to content ratings. For example, the content rating platform 101 enables users to create folders containing content items 103 of different content ratings. As an example, all G-rated voicemails will be moved to a G-rated message folder, all X-rated voicemails will be moved to an X-rated folder, and so on. In one embodiment, messages can be stored at the device level, carrier level, or at the cloud level. Message folders, for instance, can be duplicated in each location where user messages are saved. In addition, message folders can be updated on external storage, memory cards, or on centralized network servers depending on the user's preferences.

Other capabilities or possible operations for rated content items 103 include reporting and searching capabilities. For example, in a profanity rating use case, the content rating platform 101 can generate comprehensive reports on rated content items 103. Example reports include, but are not limited to: (1) how many content items 103 with abusive/curse words are received per day, week, month, year, etc.; (2) how many content items 103 are received from a given contact with abusive/curse words; (3) how many abusive/curse words are seen on an average day, week, month, year, etc.; (4) how many content items with XXX, XX, X, etc. ratings; (5) listing or content items 103 according to a ratings-based order; etc. In one embodiment, the content rating platform 101 can generate a content rating report that includes a graphical chart for a given contact or originator of content items 103 that provides a historical view of previously rated content items 103 from the contact. The graphical chart, for instance, may appear similar to a stock price chart for a given company.

In one embodiment, in a profanity rating use case, the content rating platform 101 provides the search functions that search all content items 103 for a given word or words and list them in a certain order. For example, the following search functions can be provided: (1) search for all content items 103 containing the word “fu**”; (2) search for all content items 103 from a given contact that contain a certain word. In one embodiment, the search function also gives the user the ability to report and/or delete rated content items 103.

In one embodiment, the content rating platform 101 determines whether to initiate the processing of the content, the calculating of the content rating, the selecting of the operation, or a combination thereof based on one or more contextual parameters associated with the content, the user, a device associated with the user, or a combination thereof. For example, the user may specify that content screening and rating not occur on certain dates (e.g., weekends) or certain time periods (e.g., after working hours). Additionally, the user may specify different dictionaries 107 or rating levels/criteria that are to be applied under different contexts.

FIG. 5 is a flowchart of a process for screening content based on content rating, according to one embodiment. In one embodiment, the content rating platform 101 performs the process 500 and is implemented in, for instance, a chip set including a processor and a memory as shown in FIG. 11. In addition or alternatively, the content rating application 109 may perform all or a portion of the process 500. The process 500 is a continuation of the process 400 of FIG. 4 in which the operation selected to apply on rated content items 103 is a screening operation. In one embodiment, screening functions include blocking, masking, substituting, etc. offending elements in content items 103.

For example, in step 501, the content rating platform 101 blocks or masks the one or more elements in the content to generate screened content. The following are example of possible screening functions: (1) do nothing; (2) delete a content item 103 with a certain rating; (3) modify the content item 102 to add beeps, redactions, silence, etc. to create screened content; (4) move the original content item 103 to an archive folder for future records—a folder can be configured by the user; (5) forward the content item 103 of a certain rating to another entity—e.g., to report malicious or threatening content.

In one embodiment, the masking function includes a substitution of the one or more elements identified in the content item 103. In this embodiment, the content rating platform 101 selects one or more substitute elements from a replacement dictionary. As previously noted, the content rating platform 101 replace offending elements detected in content items 103 with terms default or manually specified terms. For example, a user may specify that whenever a content item contains the word “stu***”, the content rating platform should be replace the word with “great” or any other word specified by the user in a user specified replacement dictionary. In another embodiment, the replacement dictionary may include less offensive synonyms for the offending words or elements.

In step 503, the content rating platform 101 presents the screened content in place of the content. For example, when a user requests playback of a particular content item 103 (e.g., a voicemail), the content rating application will not play back the original content item 103, but instead substitute that a version of the content item 103 that has been screened and processed according to the processes described above. In on offline mode of operation, the content rating platform 101 creates and stores the screened content item prior to the user's playback request. In an online or real-time mode of operation, the content rating platform 101 creates the screened content as the original content is played back.

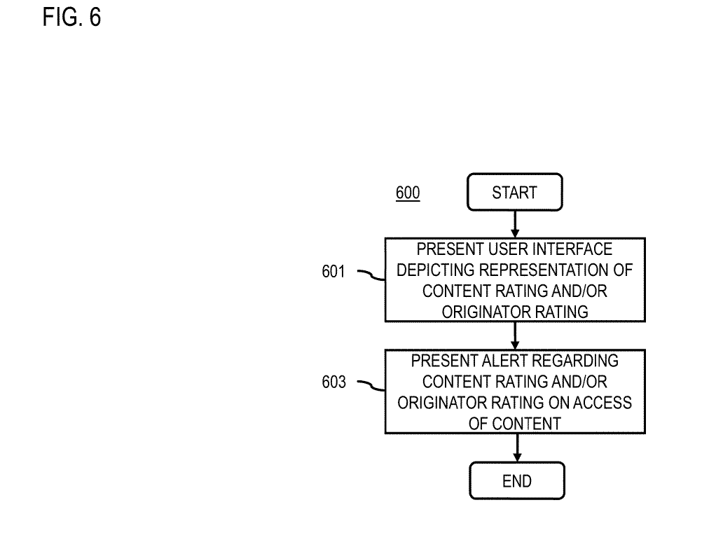

FIG. 6 is a flowchart of a process for presenting a content rating information, according to one embodiment. In one embodiment, the content rating platform 101 performs the process 600 and is implemented in, for instance, a chip set including a processor and a memory as shown in FIG. 11. In addition or alternatively, the content rating application 109 may perform all or a portion of the process 600. The process 600 is a continuation of the process 400 of FIG. 4 and assumes that content items 103 have been rated according to the process 400.

In step 601, the content rating platform 101 presents a user interface for depicting a representation of the content rating, the originator rating, or a combination thereof. In one embodiment, the content rating application can used a default set of alphanumeric representations, graphical representations, or other representation of content and/or originator ratings. For example, default representations may display rating levels as letters or abbreviations (e.g., G, X, XX, XXX, etc.; or A, B, C, D, etc.). Other representations may include icons with facial expressions. It is contemplated that the content rating platform 101 may use any representation or media mode to convey content and/or originator rating information. Examples of such representations are further discussed below.

In step 601, the content rating platform 101 presents an alert regarding the content rating on detecting a request to access the content. For example, in a voicemail use case, when a voicemail is played by the user, the voice player (or the content rating platform 101) will provide a warning if the content is of a certain rating. In one embodiment, the content rating platform 101 can present the following alert in place of the voicemail, “This voicemail has a content rating of X, XX, or XXX, do you still want to play this voicemail?” In one embodiment, a user interface with a yes or no option can be presented to receive user confirmation about whether or not to play back the voicemail.

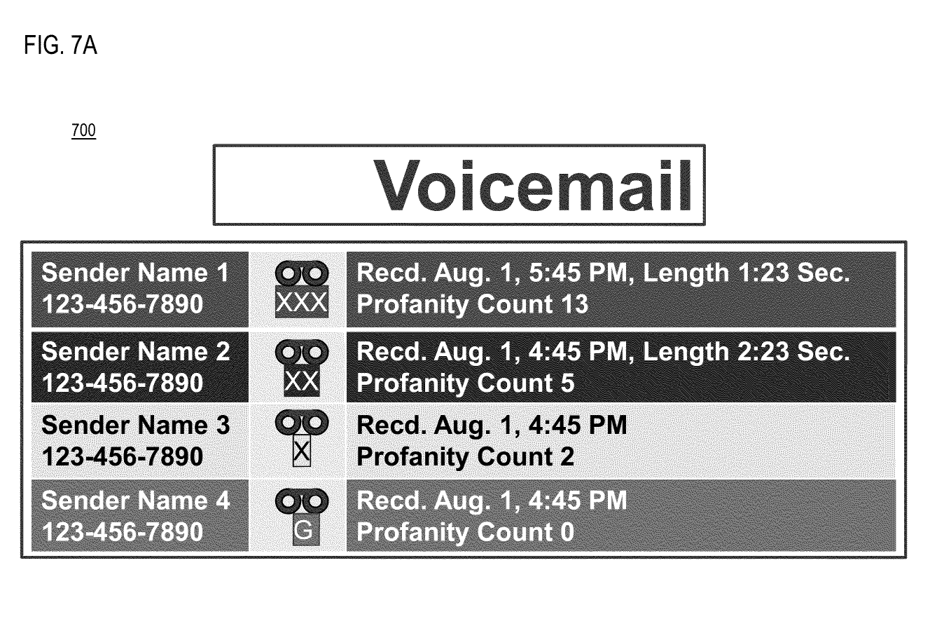

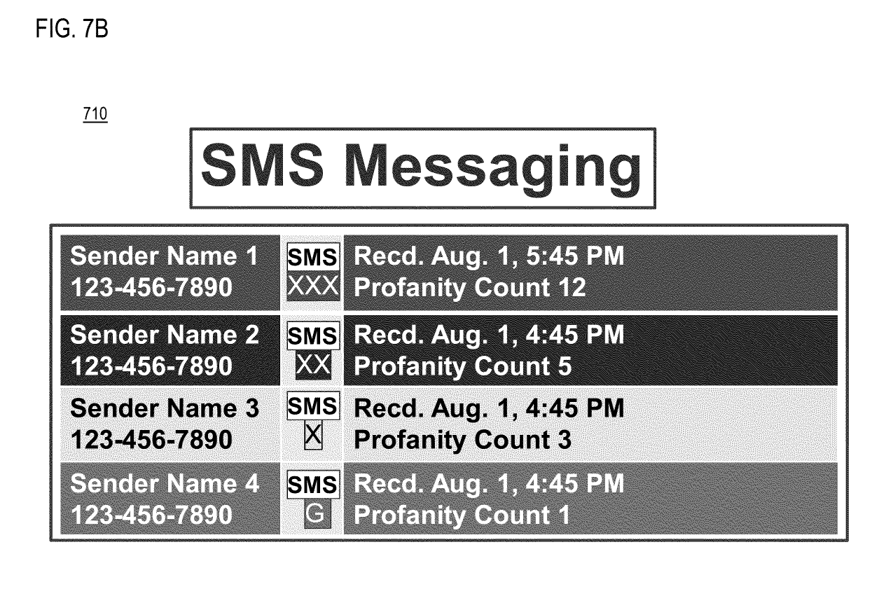

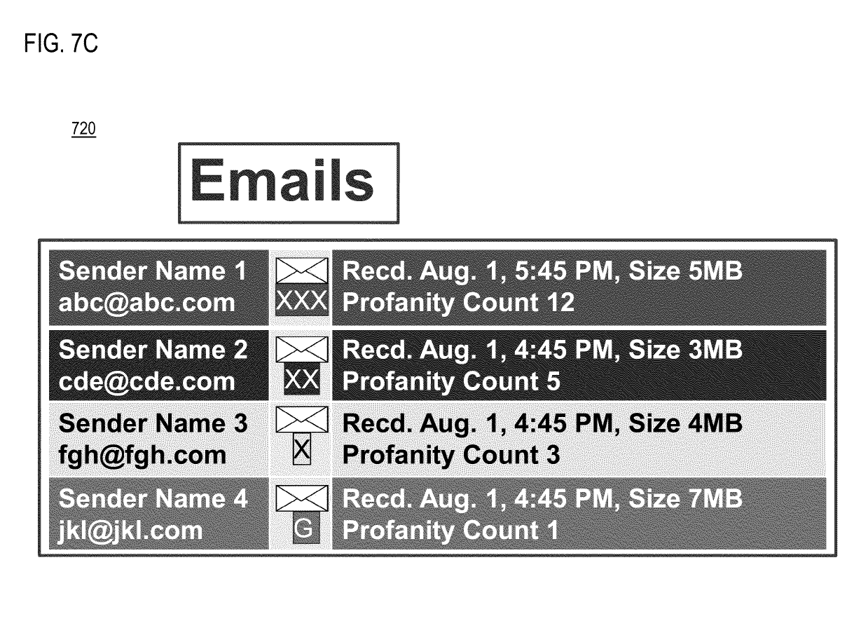

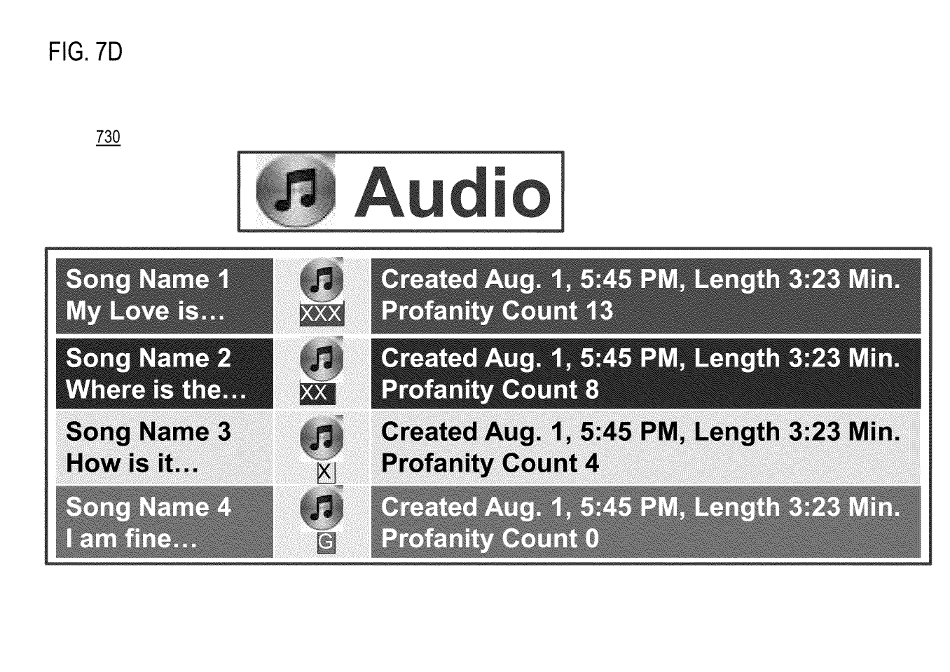

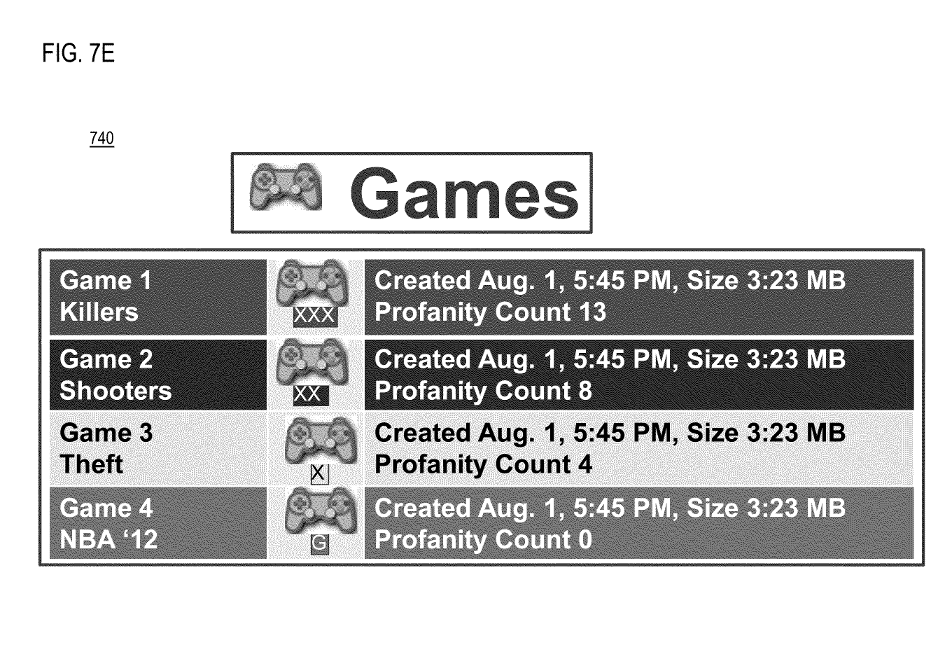

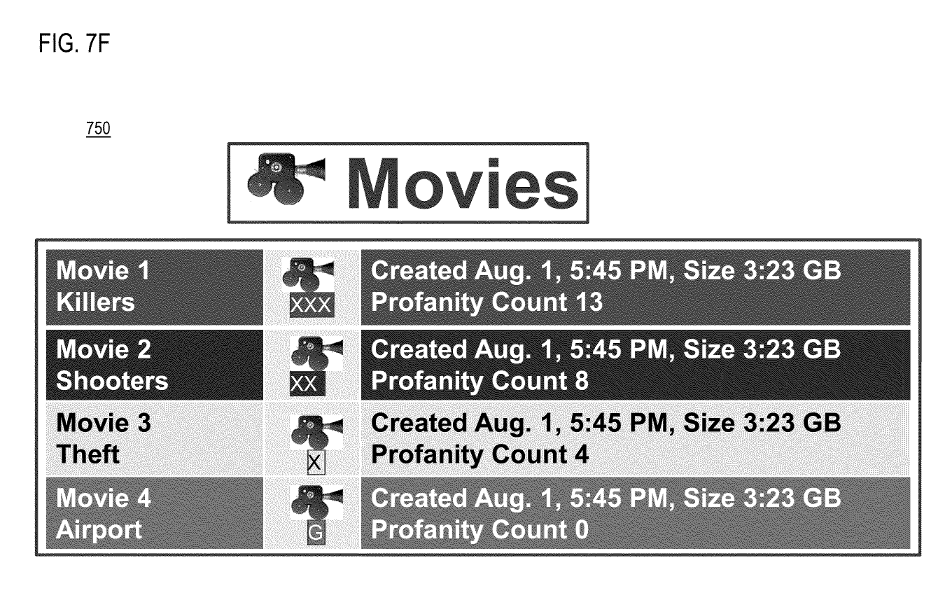

FIGS. 7A-7F are diagrams of user interfaces for presenting content ratings for different content types, according to various embodiments. As previously discussed, the content rating platform 101 enables the user to customize the presentation of content ratings. For example, user can specify icons, labels, colors, etc. for distinguishing one rating level from another. In addition, the user is able to specify ratings presentation settings on a content type basis.

For illustration and not limitation, FIGS. 7A-7F show respectively example representations of content rating information for voicemails, SMS messaging, E-mails, audio tracks, games, and movies. FIG. 7A depicts a user interface 700 that lists voicemails and their associated ratings. In this example, a voicemail icon with ratings symbols G, X, XX, and XXX is used to indicate the ratings information. In addition, color or shading can also be used to represent rating levels. It is contemplated that the content rating platform 101 can use any combination of icons, labels, colors, fonts, shading, etc. to identify rating levels. In addition, the content rating platform 101 can indicate a specific profanity count for each voicemail that warranted the rating.

User interface 710 of FIG. 7B is similar to user interface 700 except that it depicts ratings for text messaging content. In this case an SMS icon is used in place of the voicemail icon to represent the content type. Other information presented in user interface 710 remains analogous to user interface 700. Similarly, user interface 720 of FIG. 7C illustrates a user interface for presenting E-mail content ratings; user interface 730 of FIG. 7D illustrates a user interface for presenting audio track ratings information; user interface 740 of FIG. 7E illustrates a user interface for presenting game rating information; and user interface 750 of FIG. 7F illustrates a user interface for presenting move content rating information. In each case, the content rating platform 101 processes the content items to generate personalized ratings for each user or group of users.

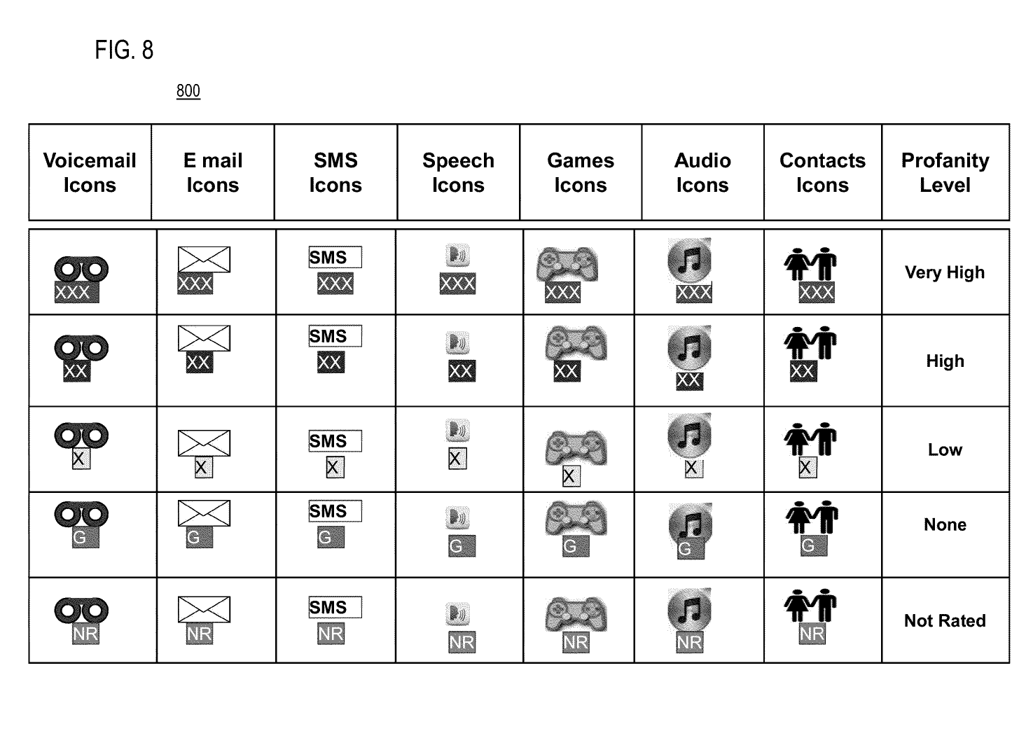

FIG. 8 is a diagram of representations of content ratings, according to one embodiment. As previously noted, the content rating platform 101 provides users with the ability to customize how content and originator ratings are presented. Table 800 of FIG. 8 illustrates example iconography to represent rating levels for different types of content. As shown, the content rating platform 101 provides icons that distinguish rating levels for voicemails, E-mails, text messages, speech content, games, audio tracks, and contacts. In one embodiment, the user may specify the number or rating levels as well as the types of content to represent in content screening and rating user interfaces. As other content types are added (e.g., applications, documents, locations, etc.), the content rating platform 101 can use default icons or ask the user to manually specify new icons.

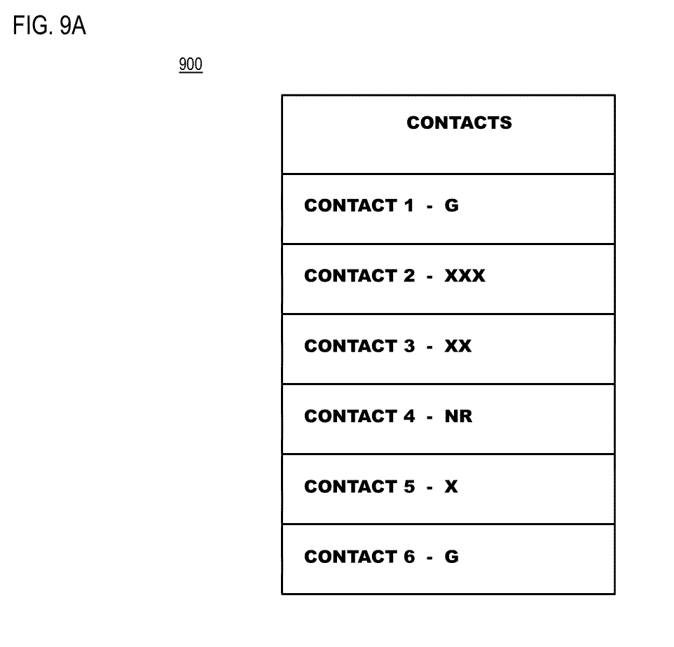

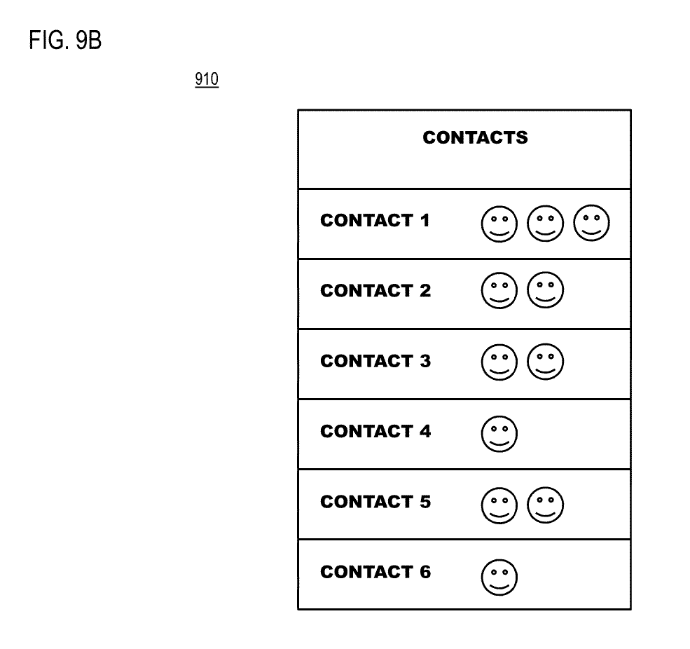

FIGS. 9A and 9B are diagrams of user interfaces for presenting rating information for content originators, according to various embodiments. In one embodiment, the content rating platform 101 provide ratings for both content items 103 and the originator of those content items. By way of example, origination of content items 103 can be correlated to contacts stored on the user's device(s) 105. User interface 900 of FIG. 9A illustrates an example contact list that shows the contact's corresponding originator ratings. As previously discussed, the originator ratings are based on the content ratings of content items originating (e.g., sent) from a particular contact. The originator ratings can be updated in real-time as new content items 103 form the contact are received. User interface 900 represents the originator ratings as alphanumeric characters (e.g., NR, G, X, XX, and XXX).

User interface 910 of FIG. 9B illustrates an alternate representation of contact or originator ratings where instead of an alphanumeric representation of the rating level for a contact, a facial expression icon is used. In this case, one to three smiley faces are used to rate whether content items 103 originating from the contact contains “happy” content (e.g., words that indicate the feeling of happiness). For example, user interface 910 indicates that Contact 1 is rated as the person with the happiest content.

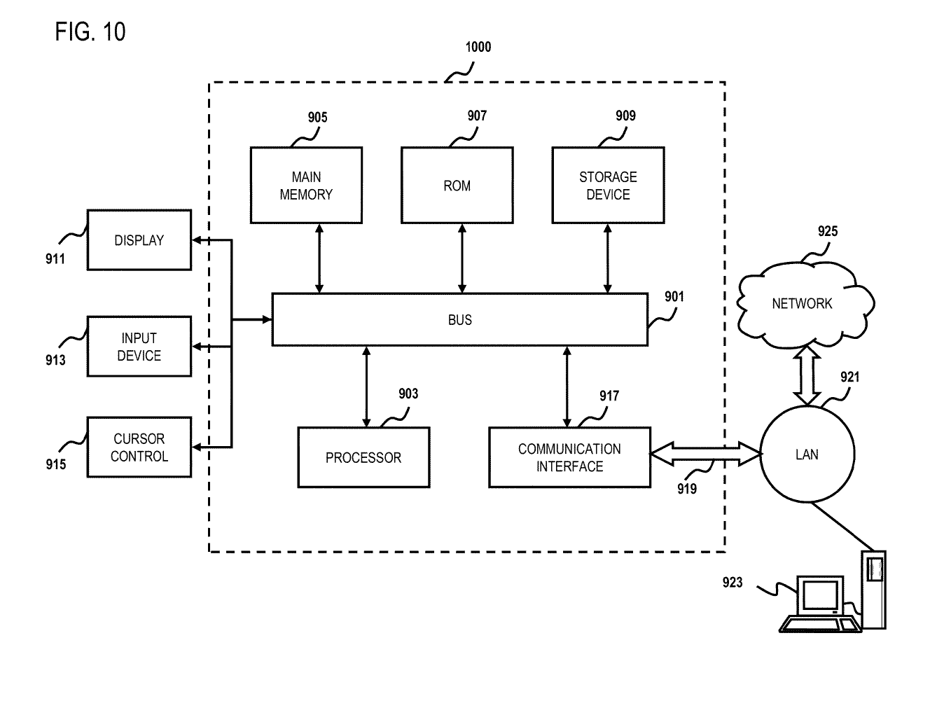

FIG. 10 is a diagram of a computer system that can be used to implement various exemplary embodiments. The computer system 1000 may be coupled via the bus 1001 to a display 1011, such as a cathode ray tube (CRT), liquid crystal display, active matrix display, or plasma display, for displaying information to a computer user. An input device 1013, such as a keyboard including alphanumeric and other keys, is coupled to the bus 1001 for communicating information and command selections to the processor 1003. Another type of user input device is a cursor control 1015, such as a mouse, a trackball, or cursor direction keys, for communicating direction information and command selections to the processor 1003 and for controlling cursor movement on the display 1011.

According to an embodiment of the invention, the processes described herein are performed by the computer system 1000, in response to the processor 1003 executing an arrangement of instructions contained in main memory 1005. Such instructions can be read into main memory 1005 from another computer-readable medium, such as the storage device 1009. Execution of the arrangement of instructions contained in main memory 1005 causes the processor 1003 to perform the process steps described herein. One or more processors in a multi-processing arrangement may also be employed to execute the instructions contained in main memory 1005. In alternative embodiments, hard-wired circuitry may be used in place of or in combination with software instructions to implement the embodiment of the invention. Thus, embodiments of the invention are not limited to any specific combination of hardware circuitry and software.

The computer system 1000 also includes a communication interface 1017 coupled to bus 1001. The communication interface 1017 provides a two-way data communication coupling to a network link 1019 connected to a local network 1021. For example, the communication interface 1017 may be a digital subscriber line (DSL) card or modem, an integrated services digital network (ISDN) card, a cable modem, a telephone modem, or any other communication interface to provide a data communication connection to a corresponding type of communication line. As another example, communication interface 1017 may be a local area network (LAN) card (e.g. for Ethernet™ or an Asynchronous Transfer Model (ATM) network) to provide a data communication connection to a compatible LAN. Wireless links can also be implemented. In any such implementation, communication interface 1017 sends and receives electrical, electromagnetic, or optical signals that carry digital data streams representing various types of information. Further, the communication interface 1017 can include peripheral interface devices, such as a Universal Serial Bus (USB) interface, a PCMCIA (Personal Computer Memory Card International Association) interface, etc. Although a single communication interface 1017 is depicted in FIG. 10, multiple communication interfaces can also be employed.

The network link 1019 typically provides data communication through one or more networks to other data devices. For example, the network link 1019 may provide a connection through local network 1021 to a host computer 1023, which has connectivity to a network 1025 (e.g. a wide area network (WAN) or the global packet data communication network now commonly referred to as the “Internet”) or to data equipment operated by a service provider. The local network 1021 and the network 1025 both use electrical, electromagnetic, or optical signals to convey information and instructions. The signals through the various networks and the signals on the network link 1019 and through the communication interface 1017, which communicate digital data with the computer system 1000, are exemplary forms of carrier waves bearing the information and instructions.

The computer system 1000 can send messages and receive data, including program code, through the network(s), the network link 1019, and the communication interface 1017. In the Internet example, a server (not shown) might transmit requested code belonging to an application program for implementing an embodiment of the invention through the network 1025, the local network 1021 and the communication interface 1017. The processor 1003 may execute the transmitted code while being received and/or store the code in the storage device 1009, or other non-volatile storage for later execution. In this manner, the computer system 1000 may obtain application code in the form of a carrier wave.

The term “computer-readable medium” as used herein refers to any medium that participates in providing instructions to the processor 1003 for execution. Such a medium may take many forms, including but not limited to non-volatile media, volatile media, and transmission media. Non-volatile media include, for example, optical or magnetic disks, such as the storage device 1009. Volatile media include dynamic memory, such as main memory 1005. Transmission media include coaxial cables, copper wire and fiber optics, including the wires that comprise the bus 1001. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the embodiments of the invention may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

FIG. 11 illustrates a chip set 1100 upon which an embodiment of the invention may be implemented. Chip set 1100 is programmed to present a slideshow as described herein and includes, for instance, the processor and memory components described with respect to FIG. 10 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip. Chip set 1100, or a portion thereof, constitutes a means for performing one or more steps of various embodiments described herein.

In one embodiment, the chip set 1100 includes a communication mechanism such as a bus 1101 for passing information among the components of the chip set 1100. A processor 1103 has connectivity to the bus 1101 to execute instructions and process information stored in, for example, a memory 1105. The processor 1103 may include one or more processing cores with each core configured to perform independently. A multi-core processor enables multiprocessing within a single physical package. Examples of a multi-core processor include two, four, eight, or greater numbers of processing cores. Alternatively or in addition, the processor 1103 may include one or more microprocessors configured in tandem via the bus 1101 to enable independent execution of instructions, pipelining, and multithreading. The processor 1103 may also be accompanied with one or more specialized components to perform certain processing functions and tasks such as one or more digital signal processors (DSP) 1107, or one or more application-specific integrated circuits (ASIC) 1109. A DSP 1107 typically is configured to process real-world signals (e.g., sound) in real time independently of the processor 1103. Similarly, an ASIC 1109 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 1103 and accompanying components have connectivity to the memory 1105 via the bus 1101. The memory 1105 includes both dynamic memory (e.g., RAM, magnetic disk, writable optical disk, etc.) and static memory (e.g., ROM, CD-ROM, etc.) for storing executable instructions that when executed perform the inventive steps described herein to controlling a set-top box based on device events. The memory 1105 also stores the data associated with or generated by the execution of the inventive steps.

While certain exemplary embodiments and implementations have been described herein, other embodiments and modifications will be apparent from this description. Accordingly, the invention is not limited to such embodiments, but rather to the broader scope of the presented claims and various obvious modifications and equivalent arrangements.

What is claimed is:

1. A method comprising:
processing content directed to or originating from a user to determine one or more elements in the content;
calculating a content rating for the content by comparing the one or more elements against at least one user-configurable dictionary; and
selecting an operation for processing the content based on the content rating.

2. A method of claim 1, wherein the operation is a screening operation, the method further comprising:
blocking or masking the one or more elements in the content to generate screened content; and
presenting the screened content in place of the content.

3. A method of claim 2, wherein the masking includes a substitution of the one or more elements, the method further comprising:
selecting one or more substitute elements from a replacement dictionary.

4. A method of claim 1, further comprising:
calculating an originator rating for an originator of the content based on the content rating.

5. A method of claim 4, further comprising:
updating the originator rating based on one or more other content ratings associated with other content directed to the user by the originator.

6. A method of claim 4, further comprising:
presenting a user interface for depicting a representation of the content rating, the originator rating, or a combination thereof.

7. A method of claim 1, further comprising:
presenting an alert regarding the content rating on detecting a request to access the content.

8. A method of claim 1, further comprising:
determining whether to initiate the processing of the content, the calculating of the content rating, the selecting of the operation, or a combination thereof based on one or more contextual parameters associated with the content, the user, a device associated with the user, or a combination thereof.

9. A method of claim 1, wherein the at least one user-configurable dictionary is based on one or more themes.

10. A method of claim 1, wherein the content includes communications content, media content, gaming content, application content, or a combination thereof.

11. An apparatus comprising at least one processor configured to:
process content directed to or originating from a user to determine one or more elements in the content;
calculate a content rating for the content by comparing the one or more elements against at least one user-configurable dictionary; and
select an operation for processing the content based on the content rating.

12. An apparatus of claim 11, wherein the operation is a screening operation, and wherein the apparatus is further configured to:
block or mask the one or more elements in the content to generate screened content; and
present the screened content in place of the content.

13. An apparatus of claim 12, wherein the masking includes a substitution of the one or more elements, and wherein the apparatus is further configured to:
select one or more substitute elements from a replacement dictionary.

14. An apparatus of claim 11, wherein the apparatus is further configured to:
calculate an originator rating for an originator of the content based on the content rating.

15. An apparatus of claim 14, wherein the apparatus is further configured to:
update the originator rating based on one or more other content ratings associated with other content directed to the user by the originator.

16. An apparatus of claim 14, wherein the apparatus is further configured to:
present a user interface for depicting a representation of the content rating, the originator rating, or a combination thereof.

17. An apparatus of claim 11, wherein the apparatus is further configured to:
determining whether to initiate the processing of the content, the calculating of the content rating, the selecting of the operation, or a combination thereof based on one or more contextual parameters associated with the content, the user, a device associated with the user, or a combination thereof.

18. A system comprising a content rating platform configured to:
process content directed to or originating from a user to determine one or more elements in the content;
calculate a content rating for the content by comparing the one or more elements against at least one user-configurable dictionary; and
select an operation for processing the content based on the content rating.

19. A system of claim 18, wherein the operation is a screening operation, and wherein the content rating platform is further configured to:
block or mask the one or more elements in the content to generate screened content; and
present the screened content in place of the content.

20. A system of claim 18, wherein the content rating platform is further configured to:
calculate an originator rating for an originator of the content based on the content rating; and
update the originator rating based on one or more other content ratings associated with other content directed to the user by the originator.
